(19) United States
(12) Patent Application Publication
(10) Pub. No.: US 2015/0178287 A1
(43) Pub. Date: Jun. 25, 2015

(54) SURVEY SYSTEM AND METHOD USING PRESENTATION MATERIAL, AND STORAGE MEDIUM HAVING PLUG-IN PROGRAM STORED THEREIN FOR GENERATING THE PRESENTATION MATERIAL

(71) Applicant: SAMSUNG SDS CO., LTD., Seoul (KR)

(72) Inventors: Dong Kyeong Kim, Seoul (KR); Seong Keun Song, Seoul (KR); Eun Seon Kim, Seoul (KR); Young Sang Kim, Suwon-si (KR); Seung Ho Lee, Bucheon-si (KR)

(73) Assignee: SAMSUNG SDS CO., LTD., Seoul (KR)

(21) Appl. No.: 14/408,155

(22) PCT Filed: Jun. 7, 2013
(86) PCT No.: PCT/KR2013/005022

§ 371 Date: Dec. 15, 2014

(30) Foreign Application Priority Data
Jun. 14, 2012 (KR) 10-2012-0063874

(51) Int. Cl. G06F 17/30

(52) U.S. Cl. CPC G06F 17/30056

(57) ABSTRACT

Provided are a survey system and method using presentation material, and a storage medium having a plug-in program stored therein for generating the presentation material. The computer-readable storage medium according to the present invention stores a computer program therein, which computer program includes a plug-in module for plugging a first graphic user interface (GUI) item into a GUI of a predetermined presentation application which is pre-installed in an object computer, in order to add a survey control object to a predetermined slide, wherein said survey control object includes a survey start button; and a survey execution module for transmitting, to a survey service server, a survey start signal for requesting the server to send survey content corresponding to the survey control object to a survey subject terminal, if the survey start button is selected during a slide show of the presentation material made using the presentation application into which the first GUI item is plugged.

### TECHNICAL FIELD

The present invention relates to a polling system using presentation material, a polling method thereof, and a storage medium storing a plug-in program for generating the presentation material. More particularly, the present invention relates to a polling system reflected with a polling scheme that makes polling contents to be included in a presentation material, transmits the polling contents to polling subjects while showing a slide show of the presentation material, and reflects a result of gathering responses to the polling contents onto the presentation material, a polling method thereof, and a storage medium for storing a plug-in program for generating the presentation material.

### BACKGROUND ART

A polling survey through the Web and presentation through a webpage of a result thereof have become a generalized scheme of the polling survey together with a polling survey through a telephone and an automated response system (ARS).

However, a programming capability to edit the webpage needs to be provided in order to perform the polling survey through the Web and there is a limitation that a web server capable of the webpage needs to be provided. Further, there is also inconvenience that polling subjects need to directly access a specific webpage to verify polling contents.

Accordingly, a new type of polling supporting technology that can perform polling for the polling subject such as a trainee by a simple method during a presentation and rapidly verify a result thereof is required to be provided.

### DISCLOSURE

### Technical Problem

The present invention has been made in an effort to provide a computer-readable storage medium storing a plug-in program to conveniently add a polling related object to a predetermined slide by extending a function of a presentation application.

The present invention has also been made in an effort to provide a program providing server transmitting the plug-in program to a terminal according to a request from a terminal installed in the presentation application by storing the plug-in program.

The present invention has also been made in an effort to provide a polling service server that manages polling using a presentation material and dynamically adds/removes a subject of the polling to/from a person positioned at a presentation place where a presentation is performed, and a polling method thereof.

The technical objects of the present invention are not limited to the aforementioned technical objects, and other technical objects, which are not mentioned above, will be apparent to those skilled in the art from the following description.

### Technical Solution

An embodiment of the present invention provides a computer-readable storage medium storing a computer program including a plug-in module which plugs a first graphic user interface (GUI) item for adding a polling control object including a polling start button to a predetermined slide, in the GUI of a predetermined presentation application preinstalled in an installation target computer; and a polling execution module which transmits a polling start signal for requesting transmission of polling contents corresponding to the polling control object to a polling subject terminal to a polling service server when the polling start button is selected while slide-showing the presentation material prepared by using the presentation application which the first GUI item is plugged in.

The polling control object may further include a polling end button, an answerer information display region, and a polling reset button. In this case, the polling execution module may transmit to the polling service server a polling end signal for requesting to stop reception of an answer for the polling contents corresponding to the polling control object when the polling end button is selected while slide-showing the presentation material prepared through the application, receive answerer information including the number of answerers from the polling service server to update information displayed in the answerer information display region simultaneously with the reception, or transmit to the polling service server a polling reset signal for requesting transmission of the polling contents corresponding to the polling control object to the polling subject terminal and initializing polling answer data when the polling reset button is selected while slide-showing the presentation material prepared through the application. The polling execution module may initialize polling result contents and display the initialized polling result contents to a predetermined slide included in the presentation when the polling reset button is selected while slide-showing the presentation material prepared through the application.

The plug-in module may further plug a second GUI item for adding a countdown object to a predetermined slide in the GUI of a predetermined presentation application preinstalled in the installation target computer, and the polling execution module may display a countdown on the predetermined slide included in the presentation when the countdown object is selected while slide-showing the presentation material prepared through the application and transmit to the polling service server a polling end signal for requesting to stop reception of an answer of polling contents corresponding to the countdown object when a countdown is completed.

The plug-in module may further plug a third GUI item for adding a polling result display object to a predetermined slide in the GUI of the predetermined presentation application preinstalled in the installation target computer, and the polling execution module may receive from the polling service server answer data provided from the polling subject terminal to the polling service server and reflect and display the answer data onto the polling result display object. The polling result display object represents information on the number of answerers for each polling item and may be displayed, for example, in formats including a chart, a table, and the like. The polling execution module may update the answer data reflected onto the polling result display object whenever the answer data input by respective polling subjects are received from the polling service server in real time.

Another embodiment of the present invention provides a program providing server, including: a storage unit storing a polling plug-in program including a plug-in module which plugs a first graphic user interface (GUI) item for adding a polling control object including a polling start button to a predetermined slide, in the GUI of a predetermined presentation application preinstalled in an installation target computer, and a polling execution module which transmits a polling start signal for requesting transmission of polling contents corresponding to the polling control object to a polling subject terminal to a polling service server when the polling start button is selected while slide-showing the presentation material prepared by using the presentation application; and a communication unit transmitting the polling plug-in program to the installation target computer.

Yet another embodiment of the present invention provides a polling service server including: a communication unit receiving, from a presentation terminal slide-showing a presentation material by using a presentation application, a polling start signal generated as a polling start button included in polling contents and the presentation material; a polling subject management unit registering as a polling subject terminal one or more terminals that respond to a probe signal broadcasted by a probe signal transmitting device installed at a presentation place; and a polling progress unit transmitting through the communication unit the polling contents or reformat contents of the polling contents to the polling subject terminal registered by the polling subject management unit in response to reception of the polling start signal and transmitting data regarding the answer to the presentation terminal when receiving a polling answer from the polling subject terminal. In this case, the presentation material may be prepared by using the presentation application in which a GUI item for adding the polling control object including the polling start button to a predetermined slide is plugged.

The probe signal transmitting device may periodically broadcast the probe signal, and the polling subject management unit may exclude a terminal that does not respond to the probe signal at a predetermined number of times or more among the terminals registered as the polling subject terminal from the polling subject terminal.

The polling service server may further include a polling viewer storing unit storing viewer application installation data for polling reception and response. In this case, the communication unit may provide the viewer application installation data to a terminal that responds to the broadcasting signal transmitted by the probe signal transmitting device.

The communication unit may receive a polling end signal generated as a polling end button included in the presentation material is selected, from the presentation terminal, and the polling progress unit may stop receiving the answer from the polling subject terminal when receiving the polling end signal.

Still another embodiment of the present invention provides a polling method which provides a polling service server, a probe signal transmitting device, and a program providing server, and includes: distributing, by the program providing server, a polling plug-in program including a plug-in module which plugs a first graphic user interface (GUI) item for adding a polling control object including a polling start button to a predetermined slide, in the GUI of a predetermined presentation application preinstalled in an installation target computer and a polling execution module which transmits a polling start signal for requesting transmission of polling contents corresponding to the polling control object to a polling subject terminal to the polling service server when the polling start button is selected while slide-showing the presentation prepared through the application; and transmitting, by the polling service server, when a polling start request signal generated as a polling start button included in the polling control object is selected while slide-showing the presentation material and polling contents, the polling contents or reformat contents of the polling contents to a predetermined polling subject terminal.

The polling method may further include, before the transmitting the polling start request signal and the polling contents to the predetermined polling subject terminal, broadcasting, by a probe signal transmitting device installed at a presentation place, a probe signal; registering, by the polling service server, at least some of one or more terminals that respond to a broadcasting signal transmitted by the probe signal transmitting device as the predetermined polling subject terminal; and transmitting, by the polling service server, viewer application installation data for polling reception and response to the predetermined polling subject terminal.

### Advantageous Effects

According to embodiments of the present invention, polling can be performed for predetermined polling subjects by using a presentation material which can be easily prepared by using the existing presentation application and a result thereof can be reflected and displayed on the presentation material.

The polling subject is automatically set as a person positioned at the presentation place, and as a result, only if the polling subject is positioned at the presentation place, the polling can be answered.

### BRIEF DESCRIPTION OF THE DRAWINGS

FIG. 1 is a diagram illustrating a configuration of a polling system according to an embodiment of the present invention;

FIG. 2 is a diagram illustrating formats of signals transmitted and received by respective devices constituting the polling system in the polling system according to the embodiment of the present invention;

FIG. 3 is a diagram illustrating an operation of a program providing server providing a plug-in program and a structure of the plug-in program according to the embodiment of the present invention;

FIG. 4 is a diagram illustrating a GUI of a presentation application in which the plug-in program is installed according to the embodiment of the present invention;

FIG. 5 is an exemplary diagram of a slide including polling contents prepared by using the presentation application in which the plug-in program is installed according to the embodiment of the present invention;

FIG. 6 is a conceptual diagram for describing a polling subject list management operation of a polling service server according to the embodiment of the present invention;

FIG. 7 is a block diagram of the polling service server according to the embodiment of the present invention;

FIG. 8 is a conceptual diagram for describing the polling subject list management operation of the polling service server and an operation of providing a polling viewer program to the polling subject according to the embodiment of the present invention;

FIG. 9 is a block diagram of the polling service server according to the embodiment of the present invention;

FIG. 10 is a flowchart of a polling method according to another embodiment of the present invention; and

FIG. 11 is a detailed flowchart of the polling method according to the embodiment of the present invention.

### MODE FOR INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Elements depicted in drawings may have exaggerated size for the clarity of explanation. Same reference numeral refers to same element throughout the whole specification, and the meaning of “and/or” includes each mentioned item and every combination of mentioned items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, but do not preclude the presence or addition of one or more other features.

Embodiments are described herein with reference to drawings that are schematic illustrations of idealized embodiments. As such, the shapes or structures of the illustrations may be modified based on manufacturing techniques. Thus, these embodiments should not be construed as limited to the particular shapes of regions illustrated in drawings but are to include deviations in particular shapes of regions illustrated in drawings. Thus, depicted regions illustrated in the drawings are intended to illustrate a specific embodiment of present invention, and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, the present invention will be described by embodiments of the present invention. In this case, it may be appreciated that respective blocks of flowcharts and combinations of the flowcharts can be executed by computer program instructions. Since the computer program instructions can be mounted on a processor of a general-use computer, a special computer, or other programmable data processing equipment, the instructions executed through the processor of the computer or other programmable data processing equipment generate means for executing functions described in the flowchart(s). Since the computer program instructions can be stored in a computer-usable or computer-readable memory that can orient the computer or other programmable data processing equipment in order to implement functions by a specific scheme, the instructions stored in the computer-usable or computer-readable memory may produce manufacturing articles including the instruction means for executing the functions described in the flowchart(s). Since the computer program instructions may be installed in the computer or other programmable data processing equipment, the instructions that perform the computer or other programmable data processing equipment by generating a process executed by the computer through execution of a series of operating steps on the computer or other programmable data processing equipment may provide steps for executing the functions described in the flowchart(s).

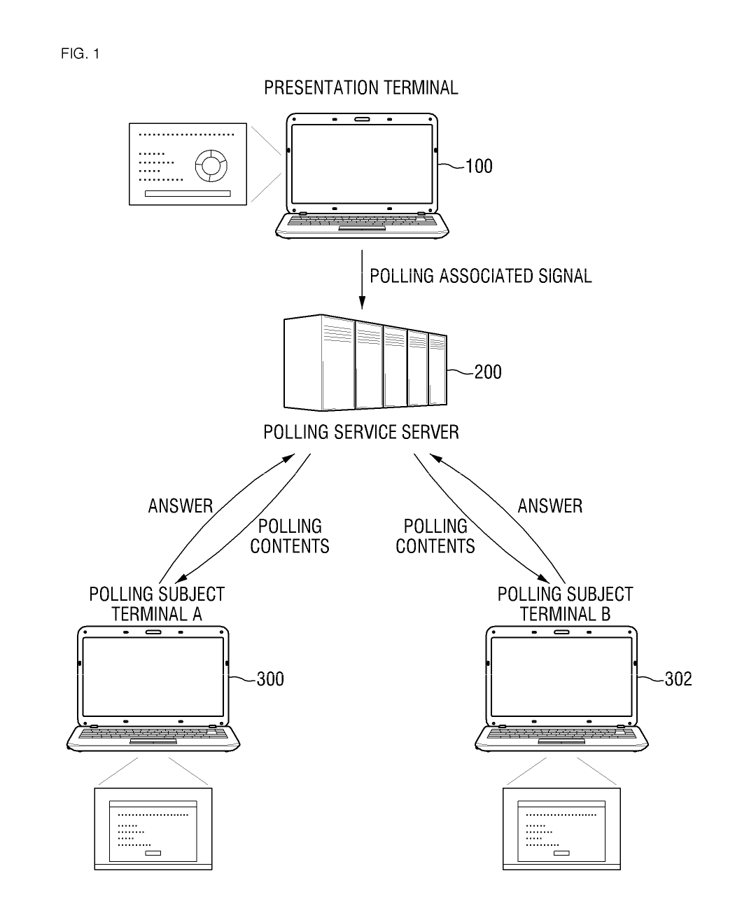

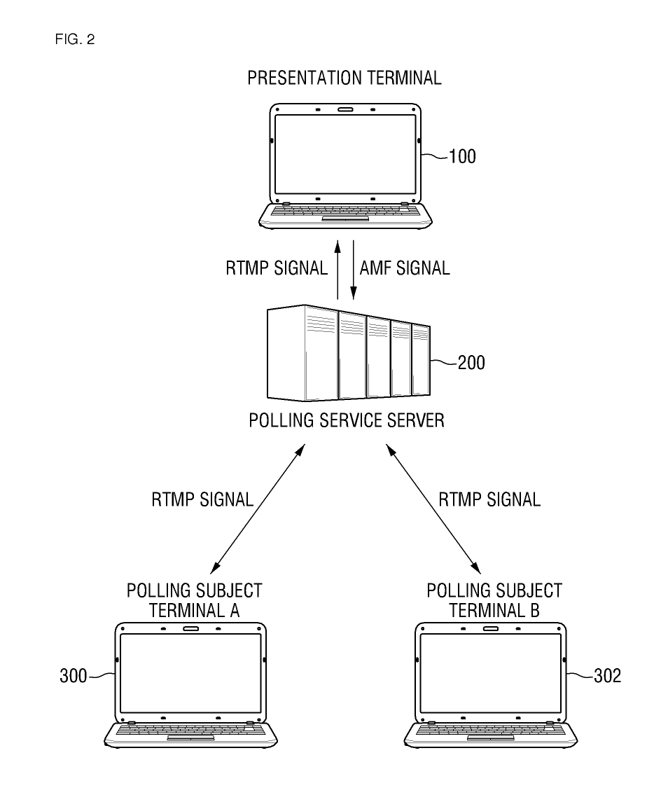

Hereinafter, a configuration and an operation of a polling system according to an embodiment of the present invention will be described with reference to FIGS. 1 and 2.

Referring to FIG. 1, the polling system according to the embodiment may include a presentation terminal 100, a polling service server 200, and one or more polling subject terminals 300 and 302. Only two polling subject terminals are present in FIG. 1 for easy description, but in the embodiment, the number of the polling subject terminals is not limited to a predetermined number.

The presentation terminal 100 and the polling subject terminals 300 and 302 are all types of terminals that have a calculation capability and a display capability.

The presentation terminal 100 is a terminal in which a presentation application is installed. The presentation application is a general-use application that provides a function of slide-showing and editing a presentation material. The presentation application may be computer programs including, for example, PowerPoint™ of Microsoft™, Hshow 2010 SE+ of Hancom Office of Hancom, and the like. The presentation application is limited to provide an application programming interface (API) so as to extend a function.

The polling subject terminals 300 and 302 may be a computer, an ultra mobile PC (UMPC), a workstation, a net-book, personal digital assistants (PDA), a portable computer, a web tablet, a wireless phone, a mobile phone, a smart phone, an e-book, a portable multimedia player (PMP), and the like.

The polling subject terminals 300 and 302 display polling contents and receive an answer to polling to install the answer in a polling viewer application transmitted to the polling service server 200.

The presentation application installed in the presentation terminal 100 slide-shows a presentation material including at least one polling content. The presentation material includes one or more slides and the slide show means sequentially displaying the respective slides according to a control by a presenter.

The presentation material may be prepared by using the presentation application in which a plug-in program for adding a polling function is plugged according to the embodiment of the present invention. The plug-in program is preferably installed even in the presentation terminal 100. The plug-in program is programmed by using the API provided by the presentation application and will be described below in more detail.

Hereinafter, an operation of the polling system according to the embodiment will be described.

First, the presentation terminal transmits a polling related signal to the polling service server 200. The polling related signal may be generated when an input for starting or ending the polling is input into the presentation terminal 100 while slide-showing the presentation material including the polling contents.

When the polling related signal is a polling start signal, the presentation terminal 100 may further transmit the polling contents together with the polling start signal. The polling contents may be transmitted more in advance than the polling start signal. The polling service server 200 receives the polling start signal to transmit the polling contents to the polling subject terminals 300 and 302.

The polling subject terminals 300 and 302 receive the polling contents to activate a preinstalled polling viewer application and display the polling contents through the polling viewer application, and receive the answer to the polling to transmit the received answer to the polling service server 200. The polling service server 200 provides the answer to the presentation terminal 100 to update a polling result to the presentation material.

According to the embodiment, polling is performed to predetermined polling subjects by using a presentation material which may be easily prepared by using the existing presentation application and the result may be reflected and displayed on the presentation material. Since the existing presentation application does not support a function to prepare a presentation material for providing a polling service by interworking with the polling service server 200, the plug-in program according to the embodiment of the present invention is plugged in or added in the existing presentation application to extend a function of the existing presentation application.

Referring back to FIG. 2, the operation of the polling system according to the embodiment will be described.

As illustrated in FIG. 2, one or more protocols may be used to transmit and receive data among the respective devices constituting the polling system. For example, a real time message protocol (RTMP) may be used for data transmission and reception between the polling service server 200 and the polling subject terminals 300 and 302 and data transmission and reception between the polling service server 200 and the presentation terminal 100.

An action message format (AMF) protocol selects one in a lecture list configured in advance, and as a result, when the polling subject terminal is automatically set as a preregistered trainee of the lecture, the AMP protocol may be used for inquiry of the lecture list between the presentation terminal 100 and the polling service server 200. The polling service server 200 may be merged with a lecture management system implemented under an Adobe-FLEX environment or connected with the lecture management system.

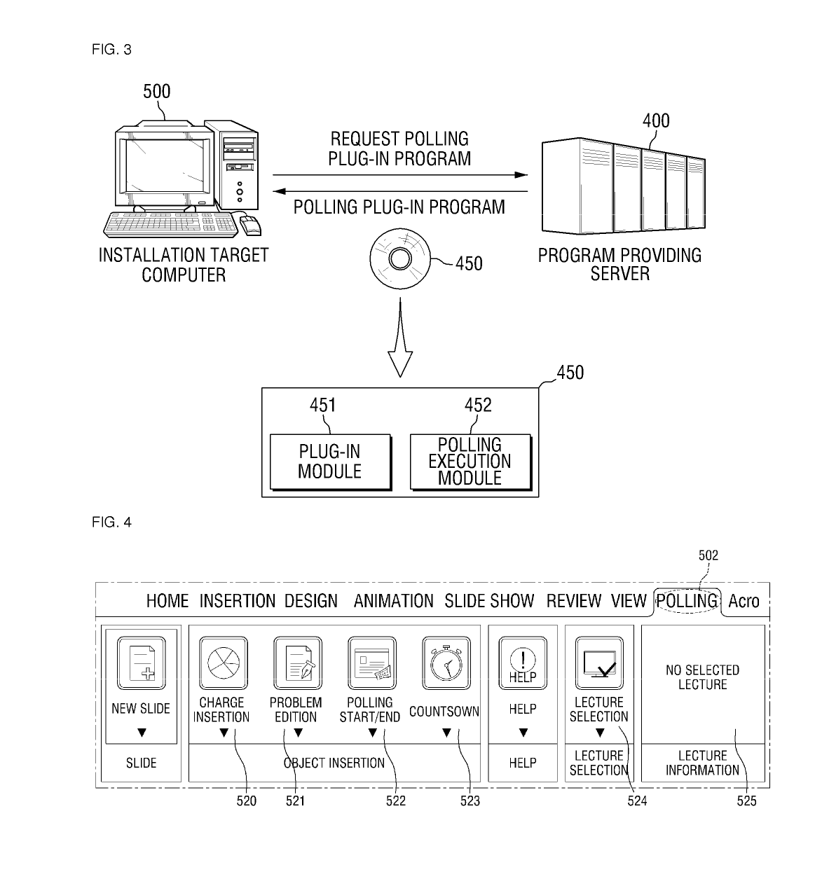

Next, configurations and operations of a program providing server and a plug-in program provided by the program providing server according to the embodiment of the present invention will be described with reference to FIG. 3.

As illustrated in FIG. 3, an installation target computer 500 accesses the program providing server 400 to request the plug-in program for adding the polling function and receives a plug-in program 450 from the program providing server 400 in response thereto to add the plug-in program in a presentation application preinstalled in the installation target computer 500. The program providing server 400 preferably additionally includes a web server providing a web interface so as for the installation target computer 500 to request a polling plug-in program.

According to the embodiment, the program providing server 400 and the polling service server 200 may be provided in the same server device.

Although not illustrated in detail in FIG. 3, the program providing server 400 includes a storage unit storing a plug-in program 450 including a plug-in module 451 that plugs a first GUI item for adding a polling control object including a polling start button to a predetermined slide in a graphic user interface (GUI) of a predetermined presentation application preinstalled in the installation target computer 500 and a polling execution module 452 that transmits a polling start signal for requesting transmission of polling contents corresponding to the polling control object to the polling subject terminal, to the polling service server when the polling start button is selected in a slide show of a presentation prepared by the application, and a communication unit transmitting the polling plug-in program to the installation target computer.

The plug-in module 451 may be implemented by using the API provided by the presentation application and the polling execution module 452 may include an RTMP interface and an AMF interface for transmitting and receiving data to and from the program providing server.

A term ‘unit’ or ‘module’ used in the embodiment means software or a hardware component such as FPGA or ASIC and the ‘unit’ or ‘module’ performs predetermined roles. However, the ‘unit’ or ‘module’ is not a meaning limited to the software or the hardware. The ‘unit’ or ‘module’ may be configured to be positioned in an addressable storage medium and configured to slide-show one or more processors. Therefore, as one example, the ‘unit’ or ‘module’ may include components such as software components, object oriented software components, class components, and task components, processes, functions, attributes, procedures, subroutines, segments of a program code, drivers, firmware, a microcode, a circuit, data, a database, data structures, tables, arrays, and variables. Functions provided in the components and ‘units’ or ‘modules’ may be joined as a smaller number of components and ‘units’ or ‘modules’ or further separated into additional components and ‘units’ or ‘modules’.

Hereinafter, the plug-in program 450 will be described with reference to FIG. 4 illustrating the GUI of the presentation application in which the plug-in program 450 is installed.

The plug-in program 450 may add at least one menu item 502 for adding the polling contents to a slide being edited to the presentation application.

When the menu item 502 is selected, tool bars are displayed and the displayed tool bar may include a first GUI item 522 for adding the polling control object including the polling start button to a predetermined slide, a second GUI item 523 for adding a countdown object to a predetermined slide, a third GUI item 520 for adding a polling result display object to a predetermined slide, and a fourth GUI item 521 for providing a template for editing question and answer examples of the polling.

The tool bar displayed when the menu item 502 is selected may further include a fifth GUI item 524 that selects one in the lecture list configured in advance to automatically set the polling subject terminal as the preregistered trainer and a lecture information display region 525 that displays information on a lecture selected through the fifth GUI item 524.

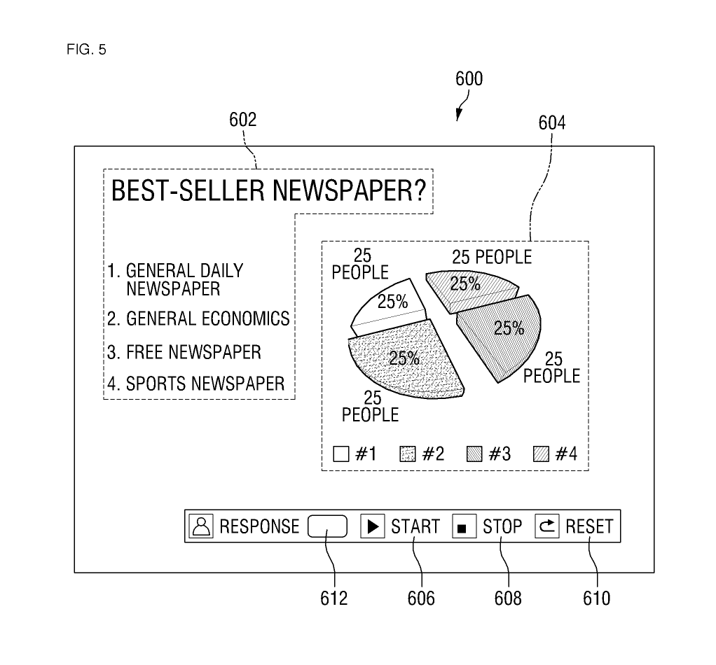

When a user selects the first to fourth GUI items 521, a function provided by the presentation application in which the plug-in program 450 is installed will be described with reference to FIG. 5. FIG. 5 is an exemplary diagram of a slide including polling contents prepared by using the presentation application in which the plug-in program 450 is installed.

Polling contents 602 are disposed in the slide 600. The polling contents 602 include examples of polling and an answer thereto and when the user selects the fourth GUI item 521, a problem template to edit the polling and answer examples may be added to the slide 600.

A polling result display object 604 is further disposed in the slide 600. When the user selects the third GUI item 520, the polling result display object 604 may be added to the slide 600. In the polling result display object 604, information on the number of persons who select respective answer example items of the polling contents 602 is displayed in a format such as a chart, or the like. The polling result display object 604 may be updated in real time whenever an answerer gives an answer. To this end, the polling execution module 452 may receive answer data provided from the polling subject terminals 300 and 302 to the polling service server 200, from the polling service server 200, reflect and display the answer data onto the polling result display object 604, and update the answer data reflected onto the polling result display object 604 whenever the answer data input by respective polling subjects are received from the polling service server 200 in real time.

When the user selects the first GUI item 522, a polling control object 614 is added to the slide 600. The polling control object 614 may include at least one of a polling start button 606, a polling end button 608, a polling reset button 610, and an answerer information display region 612.

When the presenter selects the polling start button 606 while slide-showing the presentation material including the slide 600, the polling execution module 452 transmits a polling start signal for requesting transmission of polling contents corresponding to the polling control object 614 to the polling subject terminal to the polling service server 200. The polling contents corresponding to the polling control object 614 may be the polling contents 602 included in the polling control object 614 or polling contents designated by the user at the time of adding the polling control object 614. The polling execution module 452 may transmit both the polling start signal and the polling contents to the polling service server 200, but transmit the polling contents to the polling service server 200 in advance regardless of selection of the polling start button 606.

The polling execution module 452 receives answerer information including the number of answerers from the polling service server to update information displayed in the answerer information display region 612 simultaneously with the reception. That is, the polling execution module 452 may update and display the number of answerers that respond to the polling in the answerer information display region 612 in real time. The polling execution module 452 may further display the total number of polling target answerers in the answerer information display region 612.

When the presenter selects the polling reset button 610 while slide-showing the presentation material including the slide 600, the polling execution module 452 may transmit to the polling service server 200 a polling reset signal for requesting retransmission of the polling contents corresponding to the polling control object 614 to the polling subject terminals 300 and 302 and initializing polling answer data, and initialize the polling result display object 604.

When the presenter selects the polling end button 608 while slide-showing the presentation material including the slide 608, the polling execution module 452 transmits to the polling service server 200 a polling end signal for requesting to stop reception of an answer for the polling contents corresponding to the polling control object 614. The polling service server 200 monitors the answer corresponding to the polling contents by receiving the polling end signal to stop a polling monitoring process of transmitting a monitoring result to the presentation terminal 100 and transmit a polling end notification signal to the polling subject terminals 300 and 302.

When the user selects the second GUI item 523, a countdown object (not illustrated) is added to the slide 600. When the presenter selects the countdown object while slide-showing the presentation material including the slide 600, the polling execution module 452 displays a countdown on the slide 600 and when the countdown is completed, the polling execution module 452 may transmit to the polling service server 200 the polling end signal for requesting to stop reception of an answer for the polling contents corresponding to the countdown object.

The plug-in program 450 according to the embodiment of the present invention extends the function of the presentation application to add the polling result display object 604 and the polling control object 614 capable of controlling the start and the end of the polling to the slide 600 and perform the polling by interworking with the polling service server 200.

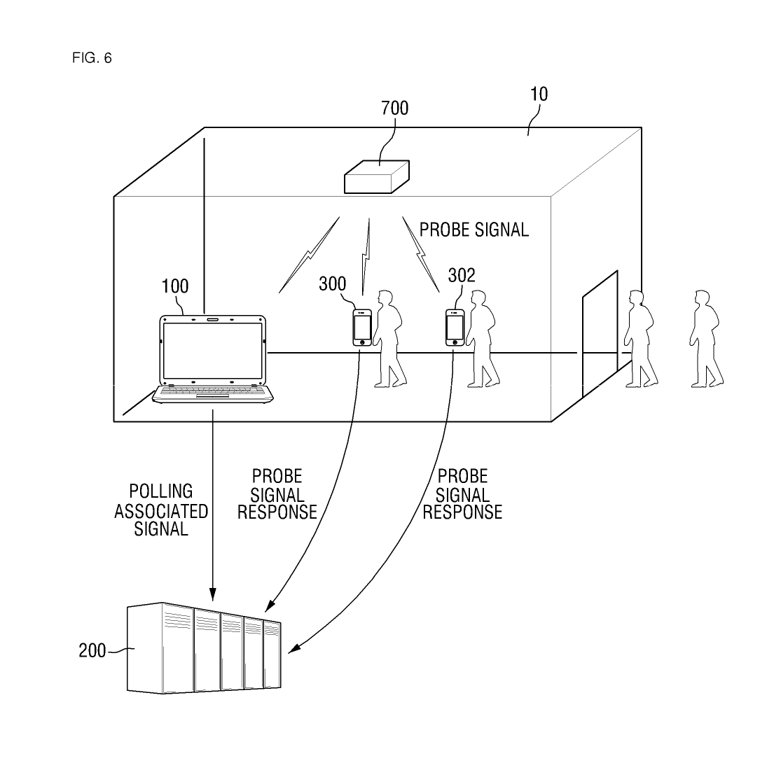

The polling service server 200 according to the embodiment of the present invention will be described with reference to FIGS. 6 to 9.

The polling service server 200 according to the embodiment has the same function as the polling service server 200 described up to now, however, further includes a function to designate the polling subject terminal in real time.

Referring to FIG. 6, the polling service server 200 may register in the polling subject terminal at least some of the terminals 300 and 302 that respond to a probe signal broadcasted from a probe signal transmitting device 700 installed at a presentation place 10. Access information of the polling service server 200 is preferably included in the probe signal. The access information may include an IP address and a port number of the polling service server 200.

For example, the terminals 300 and 302 of presentation audiences that enter the presentation place 10 such as a convention room receive the probe signal broadcasted from the probe signal transmitting device 700 and transmit a response signal thereto to the polling service server 200.

The probe signal may be periodically broadcasted. As a result, response signals of the terminals receiving the probe signal may also be periodically made. If there is an audience that leaves from the presentation place 10, the response signals will not be transmitted. By using such a point, the polling service server 200 may determine the audiences positioned at the presentation place 10 in real time.

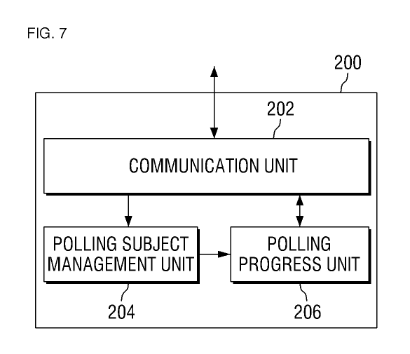

FIG. 7 illustrates a block diagram of the polling service server 200 according to the embodiment of the present invention. As illustrated in FIG. 7, the polling service server 200 may include a communication unit 202, a polling subject management unit 204, and a polling progress unit 206.

The polling subject management unit 204 registers in the polling subject terminal one or more terminals 300 and 302 that respond to the probe signal broadcasted by the probe signal transmitting device 700 installed at the presentation place 10. When it is assumed that the probe signal transmitting device 700 periodically performs the broadcasting, the polling subject management unit 204 may exclude a terminal that does not respond to the probe signal at a predetermined number of times among the terminals that are registered as the polling subject terminal from the polling subject terminal.

The communication unit 202 receives, from the presentation terminal 100 that slide-shows the presentation material by using the presentation application, the polling start signal generated as the polling start button 606 included in the polling contents 602 and the presentation material is selected. The communication unit 202 may further receive the polling end signal generated as the polling end button included in the presentation material is selected, from the presentation terminal.

The polling progress unit 206 operates by interworking with the polling execution module 452 of the plug-in program.

The polling progress unit 206 transmits the polling contents to the polling subject terminal registered by the polling subject management unit 204 through the communication unit 202 in response to the reception of the polling start signal and when the polling progress unit 206 receives a polling answer from the polling subject terminal through the communication unit 202, the polling progress unit 206 transmits data regarding the answer to the presentation terminal 100.

The polling progress unit 206 may reformat the polling contents to be effectively displayed on the polling subject terminal and thereafter, transmit the reformatted polling contents to the polling subject terminal.

The presentation material is preferably prepared by using the presentation application to which a GUI item for adding the polling control object including the polling start button to a predetermined slide is added. That is, the presentation material which is slide-shown through the presentation terminal 100 may be prepared by using the presentation application added with the GUI item according to a result of installing the plug-in application 450 according to the embodiment of the present invention.

When the polling progress unit receives the polling end signal, the polling progress unit stops the answer reception from the polling subject terminals 300 and 302.

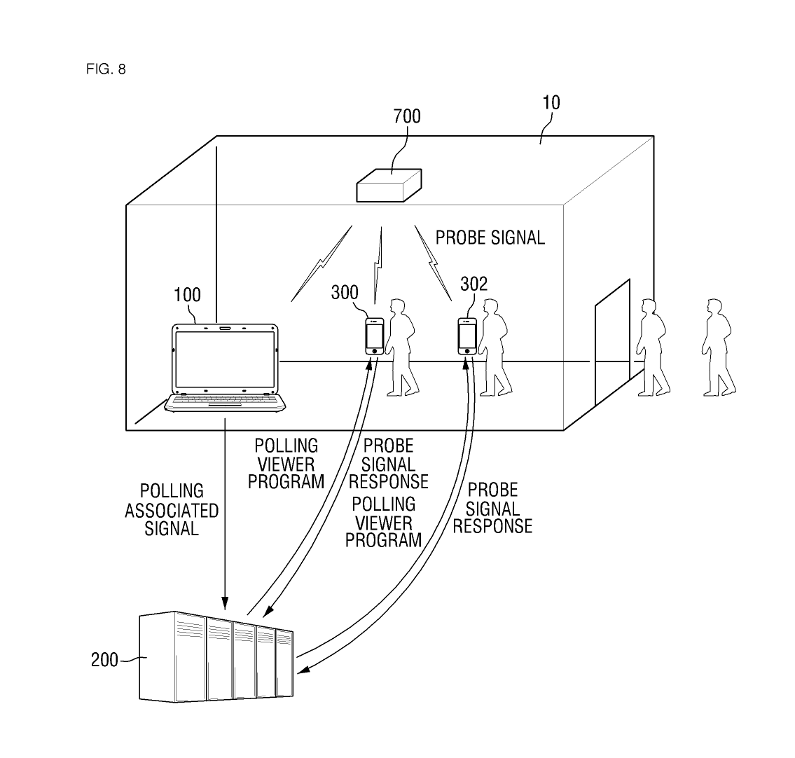

The polling service server 200 according to the embodiment may further include a function to provide the polling viewer application to the polling subject terminal. Referring to FIG. 8, the polling service server 200 may provide the polling viewer program to the polling subject terminals 300 and 302 that respond to the probe signal generated by the probe signal transmitting device 700. The polling viewer program may be provided in such a manner that an installation file may be directly transmitted to the polling subject terminals 300 and 302, but a link for a page in which the polling viewer program may be installed is provided.

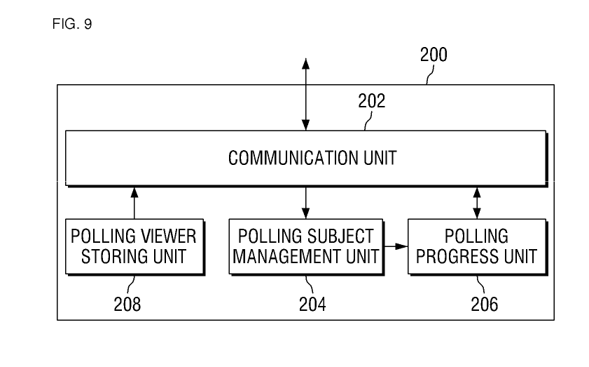

The polling service server 200 according to the embodiment may further include a polling viewer storing unit 208 storing viewer application installation data for polling reception and response as illustrated in FIG. 9 and the polling subject management unit may provide the viewer application installation data stored in the polling viewer storing unit 208 to the terminals 300 and 302 that respond to the broadcasting signal transmitted by the probe signal generating device 700.

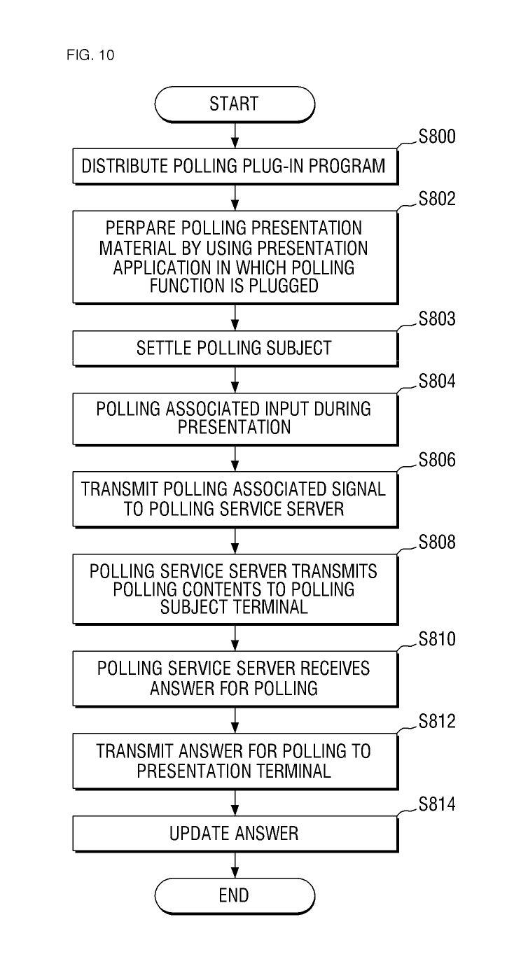

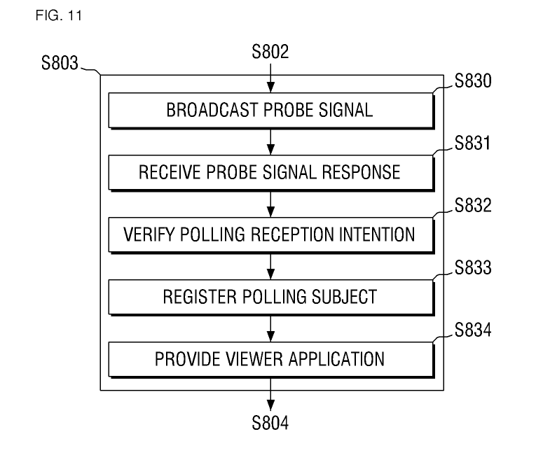

Hereinafter, a polling method according to an embodiment of the present invention will be described with reference to FIGS. 10 and 11.

First, although not illustrated in FIGS. 10 and 11, the polling service server 200, the probe signal transmitting device 700, and the program providing server 400 are provided.

First, the program providing server 400 distributes the polling plug-in program 450 for preparing the presentation material including the polling contents (S800). The polling plug-in program 450 includes a plug-in module 451 that plugs the first GUI item 522 for adding the polling control object 614 at least including the polling start button 606 to a predetermined slide, in a graphic user interface (GUI) of a predetermined presentation application preinstalled in the installation target computer 500 and a polling execution module 452 that transmits to the polling service server the polling start signal for requesting transmission of the polling contents corresponding to the polling control object to the polling subject terminal when the polling start button is selected while slide-showing the presentation prepared through the application.

Next, the presentation material including the polling contents and the polling control object corresponding thereto is prepared by using the presentation application in which the plug-in program 450 is installed (S802).

Next, a polling subject is settled (S803). For example, trainees that take a specific lecture may be settled in advance or terminals of presentation participants positioned at the presentation place may be dynamically settled as the polling subject at the time of slide-showing the presentation material.

Dynamically settling the polling subject at the time of the slide-show may be performed with reference to FIGS. 6 and 7 and a description associated therewith and will be described in time series with reference to FIG. 11. First, the probe signal transmitting device 700 installed at the presentation place 10 broadcasts the probe signal (S830) and a terminal that moves to the inside of the presentation place 10 transmits a response signal to the polling service server 200 in response to the probe signal (S831).

According to the embodiment, the polling service server 200 transmits a message for inquiring terminals that transmit the response signal of an intention of receiving the polling to register a terminal that intends to receive the polling as the polling subject (S833).

According to the embodiment, the polling service server 200 may provide the viewer application to terminals registered as the polling subject (S834).

Referring back to FIG. 10, the presentation presenter performs a polling associated input while slide-showing the presentation material through the presentation terminal 100 (S804). In the polling associated input, for example, the polling start button 606 or the polling end button 608 of the slide illustrated in FIG. 5 may be selected.

The presentation terminal 100 transmits to the polling service server 200 a polling associated signal corresponding to the polling associated input (S806). For example, when the polling start button 606 is selected, the polling service server 200 may transmit the polling contents to the polling subject terminal in response to the reception of the polling associated signal (S808).

The polling service server 200 receives an answer for the polling from the polling subject terminal (S810) to transfer the received answer to the presentation terminal 100 (S812).

The presentation terminal 100 processes the answer transferred from the polling service server 200 to update data regarding the polling answer to the presentation material (S814).

Although a few embodiments of the present invention have been described referring to the drawings, those skilled in the art will readily appreciate that many modifications are possible in the embodiments without materially departing from the novel teachings and advantages of the present invention. Therefore, it is to be understood that the disclosed embodiments of the present invention are just exemplary embodiments of the present invention.

### INDUSTRIAL APPLICABILITY

According to the present invention, a plug-in capable of supporting a function to prepare a slide for a polling survey can be provided to the existing presentation application.

What is claimed is:

1. A computer-readable storage medium with a computer program stored therein, the storage medium comprising:
a plug-in module which plugs a first graphic user interface (GUI) item for adding a polling control object including a polling start button to a predetermined slide, in the GUI of a predetermined presentation application preinstalled in an installation target computer and operates in preparing a presentation material; and
a polling execution module which transmits a polling start signal for requesting transmission of polling contents corresponding to the polling control object to a polling subject terminal to a polling service server when the polling start button is selected while slide-showing the presentation material prepared by using the presentation application which the first GUI item is plugged in,
wherein the polling start button selected during the slide show is included in the polling control object added to the slide of the presentation material by operating the first GUI item.

2. The computer-readable storage medium of claim 1, wherein the polling control object further includes a polling end button, and
the polling execution module transmits to the polling service server a polling end signal for requesting to stop reception of an answer for the polling contents corresponding to the polling control object when the polling end button is selected while slide-showing the presentation material prepared through the application.

3. The computer-readable storage medium of claim 1, wherein the polling control object further includes an answerer information display region, and
the polling execution module receives answerer information including the number of answerers from the polling service server to update information displayed in the answerer information display region simultaneously with the reception.

4. The computer-readable storage medium of claim 1, wherein the polling control object further includes a polling reset button, and
the polling execution module transmits to the polling service server a polling reset signal for requesting retransmission of the polling contents corresponding to the polling control object to the polling subject terminal and initializing polling answer data when the polling reset button is selected while slide-showing the presentation material prepared through the application.

5. The computer-readable storage medium of claim 4, wherein the polling execution module initializes polling result contents and displays the initialized polling result contents to a predetermined slide included in the presentation when the polling reset button is selected while slide-showing the presentation material prepared through the application.

6. The computer-readable storage medium of claim 1, wherein the plug-in module further plugs a second GUI item for adding a countdown object to a predetermined slide in the GUI of a predetermined presentation application preinstalled in the installation target computer, and
the polling execution module displays a countdown on the predetermined slide included in the presentation when the countdown object is selected while slide-showing the presentation material prepared through the application and transmits to the polling service server a polling end signal for requesting to stop reception of an answer for polling contents corresponding to the countdown object when a countdown is completed.

7. The computer-readable storage medium of claim 1, wherein the plug-in module further plugs a third GUI item for adding a polling result display object to a predetermined slide in the GUI of the predetermined presentation application preinstalled in the installation target computer, and
the polling execution module receives from the polling service server answer data provided from the polling subject terminal to the polling service server and reflects and displays the answer data onto the polling result display object.

8. The computer-readable storage medium of claim 7, wherein the polling execution module updates the answer data reflected onto the polling result display object whenever the answer data input by respective polling subjects are received from the polling service server in real time.

9. A program providing server comprising:
a storage unit storing a polling plug-in program including a plug-in module which plugs a first graphic user interface (GUI) item for adding a polling control object including a polling start button to a predetermined slide, in the GUI of a predetermined presentation application preinstalled in an installation target computer and operates in preparing a presentation material, and a polling execution module which transmits a polling start signal for requesting transmission of polling contents corresponding to the polling control object to a polling subject terminal to a polling service server when the polling start button is selected while slide-showing the presentation material prepared through the application; and
a communication unit transmitting the polling plug-in program to the installation target computer,
wherein the polling start button selected during the slide show is included in the polling control object added to the slide of the presentation material by operating the first GUI item.

10. A polling service server comprising:
a communication unit receiving, from a presentation terminal slide-showing a presentation material by using a presentation application, a polling start signal generated as a polling start button included in polling contents and the presentation material;
a polling subject management unit registering as a polling subject terminal one or more terminals that respond to a probe signal broadcasted by a probe signal transmitting device installed at a presentation place; and
a polling progress unit transmitting through the communication unit the polling contents or reformat contents of the polling contents to the polling subject terminal registered by the polling subject management unit in response to reception of the polling start signal and transmitting data regarding the answer to the presentation terminal when receiving a polling answer from the polling subject terminal,
wherein the presentation material is prepared by using the presentation application in which a GUI item for adding the polling control object including the polling start button to a predetermined slide is plugged, and
the polling start button selected during the slide show is included in the polling control object added to the slide of the presentation material by operating the plug-in GUI item.

11. The computer-readable storage medium of claim 10, wherein the probe signal transmitting device periodically broadcasts the probe signal, and
the polling subject management unit excludes a terminal that does not respond to the probe signal at a predetermined number of times or more among the terminals registered as the polling subject terminal from the polling subject terminal.

12. The computer-readable storage medium of claim 10, further comprising:
a polling viewer storing unit storing viewer application installation data for polling reception and response,
wherein the communication unit provides the viewer application installation data to a terminal that responds to the broadcasting signal transmitted by the probe signal transmitting device.

13. The computer-readable storage medium of claim 10, wherein the communication unit receives a polling end signal generated as a polling end button included in the presentation material is selected, from the presentation terminal, and
the polling progress unit stops receiving the answer from the polling subject terminal when receiving the polling end signal.

14. A polling method using a presentation material, the polling method comprising:
distributing, by a program providing server, a polling plug-in program including a plug-in module which plugs a first graphic user interface (GUI) item for adding a polling control object including a polling start button to a predetermined slide, in the GUI of a predetermined presentation application preinstalled in an installation target computer and a polling execution module which transmits a polling start signal for requesting transmission of polling contents corresponding to the polling control object to a polling subject terminal to a polling service server when the polling start button is selected while slide-showing the presentation material including one or more slides prepared to include the polling control object by operating the first GUI item; and
transmitting, by a polling service server, when a polling start request signal generated as a polling start button included in the polling control object is selected while slide-showing the presentation material and polling contents from a terminal that performs the slide show, the polling contents or reformat contents of the polling contents to a predetermined polling subject terminal.

15. The computer-readable storage medium of claim 14, further comprising:
before the transmitting the polling start request signal and the polling contents to the predetermined polling subject terminal,
broadcasting, by a probe signal transmitting device installed at a presentation place, a probe signal;
registering, by the polling service server, at least some of one or more terminals that respond to a broadcasting signal transmitted by the probe signal transmitting device as the predetermined polling subject terminal; and
transmitting, by the polling service server, viewer application installation data for polling reception and response to the predetermined polling subject terminal.
